(19) United States
(12) Patent Application Publication
(10) Pub. No.: US 2026/0161391 A1
(43) Pub. Date: Jun. 11, 2026

(54) SYSTEM AND METHOD FOR RELATIVE ESTIMATIONS USING MACHINE LEARNING

(71) Applicant: JPMorgan Chase Bank, N.A., New York, NY (US)

(72) Inventors: Angad NANDA, Mumbai (IN); Srilatha KOKA, Frisco, TX (US)

(73) Assignee: JPMorgan Chase Bank, N.A., New York, NY (US)

(21) Appl. No.: 19/039,064

(22) Filed: Jan. 28, 2025

(30) Foreign Application Priority Data
Dec. 11, 2024 (IN) 202411097856

(51) Int. Cl. G06F 8/77

(52) U.S. Cl. CPC G06F 8/77

(57) ABSTRACT

Various methods and processes, apparatuses/systems, and media for improving performance of an agile project management tool (PMT) are disclosed. A processor trains a machine learning model (MLM) with historical story point data corresponding to a project to be developed via the PMT; implements a clustering algorithm that automatically generates T-shirt size categories based on the historical story point data; dynamically generates first mappings data that corresponds to relationships between the T-shirt size and the historical story point data at various levels; implements a learning algorithm onto the PMT for the MLM to continuously learn and adjust mappings based on new project data thereby improving performance of the PMT, providing recommendations data that evolve over time; displays the recommendations data onto a graphical user interface (GUI) that provides a platform for decision making and planning in completing the project; and receive user input, via the GUI, to complete the project.

### CROSS-REFERENCE TO RELATED APPLICATIONS

This application claims the benefit of priority from Indian Provisional Patent Application No. 202411097856, filed Dec. 11, 2024, which is herein incorporated by reference in its entirety.

### TECHNICAL FIELD

This disclosure generally relates to data processing, and, more particularly, to methods and apparatuses for implementing a platform, language, cloud, and database agnostic relative estimation and sizing recommendation module configured to automatically and dynamically analyze, group, and categorize story point data using machine learning algorithms.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Developing computer software and program flows via an agile project management tool may prove to be a complicated process. A myriad of different activities may be included. These may include problem definition, requirements development, construction planning, high-level design, detailed design, coding and debugging, unit testing, integration, and system testing and maintenance, for example. The main activities of computer software and program flow construction may include detailed design, coding, debugging, integration and testing including unit testing and integration testing. The quality of construction directly affects the quality of the software or program and impacts both upstream and downstream applications and programs. Moreover, a management lead may also would like to know a road map of when a delivery of a certain software product may be made within a certain timeframe.

A variety of current technologies exist for monitoring the software development process; however, these technologies possess significant limitations.

For example, in traditional agile methodologies, teams often use abstract concepts like “Story Points” or “T-shirt Sizes” to estimate the effort required for various tasks. While this approach may encourage relative sizing and avoids the pitfalls of fixed time-based estimates, it lacks a concrete, data-driven connection to actual effort or complexity. This limitation may lead to inconsistencies across products, teams, projects, and time, making it difficult to plan resources effectively or compare performance metrics.

Accurate estimation of task effort may prove to be a cornerstone of successful agile project management. T-shirt sizing is a forecasting technique typically used for larger bodies of work such as initiatives and epics (features), while requirements are still unclear and high-level—provides a relative, intuitive sizing approach, categorizing tasks into sizes like XS, S, M, L, and XL.

Story points, in contrast, are more granular and are typically used for precise estimations once requirements have been clearly defined-they offer a more quantitative estimation, assigning numerical values to represent the effort required for tasks.

While T-shirt sizing is accessible and easy for teams to use, it often lacks the precision required for detailed project planning and accurate velocity calculations. Story points, although more granular, may be challenging for teams to estimate consistently, leading to variability in planning accuracy. This challenge may be particularly pronounced at the epic and initiative levels, where estimation complexity increases.

Existing solutions typically employ static, subjective (i.e., manual) mappings between T-shirt sizes and story points, leading to inconsistencies and inaccuracies. These predefined mappings do not account for the unique characteristics and historical performance of individual products, teams or projects, resulting in a one-size-fits-all approach that may not suit all scenarios, thereby substantially reducing performance of the project management tool, reducing processing speed of the project management tool in delivering a project, failing to adapt to changing team dynamics, and subjecting the project management tool to various malicious data breach, etc., due to the manual nature of data mapping.

Thus, there is a need for an advanced tool that may address the above-noted deficiencies of conventional tools in agile project management.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic relative estimation and sizing recommendation module configured to implement artificial intelligence and machine learning algorithms to automatically analyze, group, and categorize story point data for dynamically mapping features data corresponding to products and teams to story points in agile project management systems and processes, thereby substantially improving processing speed of overall system in connection with the project management systems and processes and protecting the overall system from potential data breach, but the disclosure is not limited thereto.

For example, the relative estimation and sizing recommendation module disclosed herein, by leveraging machine learning-particularly K-means clustering, may be configured to analyze historical data to generate adaptive, data-driven mappings between intuitive T-shirt sizes and precise story points, thereby automatically adapting to changing team dynamics or project complexities, effectively handling complex patterns and outliers accounting for the nuances of different products, teams, projects, and changing circumstances over time, but the disclosure is not limited thereto.

In some embodiments, a method for improving performance of a project management tool by utilizing one or more processors along with allocated memory is disclosed. The method may include: training a machine learning model with historical story point data corresponding to a project to be developed via the project management tool; implementing a clustering algorithm, by utilizing the machine learning model, that automatically generates T-shirt size categories based on the historical story point data; dynamically generating first mappings data that corresponds to relationships between the T-shirt size and the historical story point data at various levels recognizing that different contexts require different scales of measurement to complete the project; implementing a learning algorithm onto the project management tool, by utilizing the machine learning model, for the machine learning model to continuously learn and adjust mappings based on new project data thereby improving performance of the project management tool, providing team-specific and project-specific recommendations data that evolve over time; displaying the recommendations data onto a graphical user interface that provides a platform for decision making and planning in completing the project; and receiving user input, via the graphical user interface, to complete the project.

In some embodiments, in implementing the learning algorithm, the method may further include: periodically transmitting new updated dataset corresponding to the project into the project management tool; re-running, by utilizing the machine learning model, the clustering algorithm on the new updated dataset; and generating, in response to re-running, new mappings data that maps new T-shirt size to the historical story point data based on results data output by re-running the clustering algorithm.

In some embodiments, the method may further include: comparing, by utilizing the graphical user interface, the new mappings data with the first mappings data to identify trends or significant shifts; generating difference data in response to comparing the new mappings data with the first mappings data; and re-training the machine learning model with the difference data thereby improving performance of the machine learning model.

In some embodiments, in implementing the clustering algorithm, the method may further include: implementing a K-means clustering algorithm; and grouping similar story point values into a number of clusters, each corresponding to a specific T-shirt size.

In some embodiments, the method may further include: customizing the number of clusters as defined during initialization and configuration in connection with developing the project.

In some embodiments according to the method, both the T-shirt size and the story point may correspond to a forecasting technique in estimating effort required for various tasks corresponding to the project, but the disclosure is not limited thereto.

In some embodiments according to the method, the various levels may include initiative level, feature level, project level, and team level corresponding to the project to be developed via the project management tool, but the disclosure is not limited thereto.

In some embodiments, a system for improving performance of a project management tool is disclosed. The system may include: a processor and a memory operatively connected to the processor via a communication interface, the memory storing computer readable instructions, when executed, may cause the processor to: train a machine learning model with historical story point data corresponding to a project to be developed via the project management tool; implement a clustering algorithm, by utilizing the machine learning model, that automatically generates T-shirt size categories based on the historical story point data; dynamically generate first mappings data that corresponds to relationships between the T-shirt size and the historical story point data at various levels recognizing that different contexts require different scales of measurement to complete the project; implement a learning algorithm onto the project management tool, by utilizing the machine learning model, for the machine learning model to continuously learn and adjust mappings based on new project data thereby improving performance of the project management tool, providing team-specific and project-specific recommendations data that evolve over time; display the recommendations data onto a graphical user interface that provides a platform for decision making and planning in completing the project; and receive user input, via the graphical user interface, to complete the project.

In some embodiments, in implementing the learning algorithm, the processor may be further configured to: periodically transmit new updated dataset corresponding to the project into the project management tool; re-run, by utilizing the machine learning model, the clustering algorithm on the new updated dataset; and generate, in response to re-running, new mappings data that maps new T-shirt size to the historical story point data based on results data output by re-running the clustering algorithm.

In some embodiments, the processor may be further configured to: compare, by utilizing the graphical user interface, the new mappings data with the first mappings data to identify trends or significant shifts; generate difference data in response to comparing the new mappings data with the first mappings data; and re-train the machine learning model with the difference data thereby improving performance of the machine learning model.

In some embodiments, in implementing the clustering algorithm, the processor may be further configured to: implement a K-means clustering algorithm; and group similar story point values into a number of clusters, each corresponding to a specific T-shirt size.

In some embodiments, the processor may be further configured to: customize the number of clusters as defined during initialization and configuration in connection with developing the project.

In some embodiments according to the system, both the T-shirt size and the story point may correspond to a forecasting technique in estimating effort required for various tasks corresponding to the project, but the disclosure is not limited thereto.

In some embodiments according to the system, the various levels may include initiative level, feature level, project level, and team level corresponding to the project to be developed via the project management tool, but the disclosure is not limited thereto.

In some embodiments, a non-transitory computer readable medium configured to store instructions for improving performance of a project management tool is disclosed. The instructions, when executed, may cause a processor to perform the following: training a machine learning model with historical story point data corresponding to a project to be developed via the project management tool; implementing a clustering algorithm, by utilizing the machine learning model, that automatically generates T-shirt size categories based on the historical story point data; dynamically generating first mappings data that corresponds to relationships between the T-shirt size and the historical story point data at various levels recognizing that different contexts require different scales of measurement to complete the project; implementing a learning algorithm onto the project management tool, by utilizing the machine learning model, for the machine learning model to continuously learn and adjust mappings based on new project data thereby improving performance of the project management tool, providing team-specific and project-specific recommendations data that evolve over time; displaying the recommendations data onto a graphical user interface that provides a platform for decision making and planning in completing the project; and receiving user input, via the graphical user interface, to complete the project.

In some embodiments, in implementing the learning algorithm, the instructions, when executed, may cause the processor to further perform the following: periodically transmitting new updated dataset corresponding to the project into the project management tool; re-running, by utilizing the machine learning model, the clustering algorithm on the new updated dataset; and generating, in response to re-running, new mappings data that maps new T-shirt size to the historical story point data based on results data output by re-running the clustering algorithm.

In some embodiments, the instructions, when executed, may cause the processor to further perform the following: comparing, by utilizing the graphical user interface, the new mappings data with the first mappings data to identify trends or significant shifts; generating difference data in response to comparing the new mappings data with the first mappings data; and re-training the machine learning model with the difference data thereby improving performance of the machine learning model.

In some embodiments, in implementing the clustering algorithm, the instructions, when executed, may cause the processor to further perform the following: implementing a K-means clustering algorithm; and grouping similar story point values into a number of clusters, each corresponding to a specific T-shirt size.

In some embodiments, the instructions, when executed, may cause the processor to further perform the following: customizing the number of clusters as defined during initialization and configuration in connection with developing the project.

In some embodiments according to the non-transitory computer readable medium, both the T-shirt size and the story point may correspond to a forecasting technique in estimating effort required for various tasks corresponding to the project, but the disclosure is not limited thereto.

In some embodiments according to the non-transitory computer readable medium, the various levels may include initiative level, feature level, project level, and team level corresponding to the project to be developed via the project management tool, but the disclosure is not limited thereto.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic relative estimation and sizing recommendation module configured to automatically and dynamically analyze, group, and categorize story point data in an agile project management tool in accordance with an embodiment.

FIG. 2 illustrates a diagram of a network environment with a platform, language, database, and cloud agnostic relative estimation and sizing recommendation device in accordance with an embodiment.

FIG. 3 illustrates a system diagram for implementing a platform, language, database, and cloud agnostic relative estimation and sizing recommendation device having a platform, language, database, and cloud agnostic relative estimation and sizing recommendation module in accordance with an embodiment.

FIG. 4 illustrates a system diagram for implementing a platform, language, database, and cloud agnostic relative estimation and sizing recommendation module of FIG. 3 in accordance with an embodiment.

FIG. 5 illustrates an architecture diagram implemented by the platform, language, database, and cloud agnostic relative estimation and sizing recommendation module of FIG. 4 for automatically and dynamically analyzing, grouping, and categorizing story point data in an agile project management tool in accordance with an embodiment.

FIG. 6 illustrates a flow chart of a process implemented by the platform, language, database, and cloud agnostic relative estimation and sizing recommendation module of FIG. 4 for automatically and dynamically analyzing, grouping, and categorizing story point data in an agile project management tool in accordance with an embodiment

FIG. 7 illustrates a table of input data utilized by the platform, language, database, and cloud agnostic relative estimation and sizing recommendation module of FIG. 4 in accordance with an embodiment.

FIG. 8 illustrates an architecture implemented by the platform, language, database, and cloud agnostic relative estimation and sizing recommendation module of FIG. 4 that illustrates top-down relationship between story point data in accordance with an embodiment.

FIG. 9 illustrates a table of recommendations output by the platform, language, database, and cloud agnostic relative estimation and sizing recommendation module of FIG. 4 in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, existing solutions typically employ static, subjective (i.e., manual) mappings between T-shirt sizes and story points, leading to inconsistencies and inaccuracies. These predefined mappings do not account for the unique characteristics and historical performance of individual products, teams or projects, resulting in a one-size-fits-all approach that may not suit all scenarios, thereby substantially reducing performance of the project management tool, reducing processing speed of the project management tool in delivering a project, failing to adapt to changing team dynamics, and subjecting the project management tool to various malicious data breach, etc., due to the manual nature of data mapping.

The present disclosure, through one or more of its various aspects, embodiments, and/or specific features or sub-components, provides, among other features, various systems, servers, devices, methods, media, programs, and platforms for implementing a platform, language, cloud, and database agnostic relative estimation and sizing recommendation module configured to implement artificial intelligence and machine learning algorithms to automatically analyze, group, and categorize story point data for dynamically mapping features data corresponding to products and teams to story points in agile project management systems and processes, thereby substantially improving processing speed of overall system in connection with the project management systems and processes and protecting the overall system from potential data breach, but the disclosure is not limited thereto.

For example, the relative estimation and sizing recommendation module disclosed herein, by leveraging machine learning-particularly K-means clustering, may be configured to analyze historical data to generate adaptive, data-driven mappings between intuitive T-shirt sizes and precise story points, providing a “translation” between abstract T-shirt sizes and concrete story points based on historical project data, thereby automatically and dynamically adapting to changing team dynamics or project complexities, effectively handling complex patterns and outliers accounting for the nuances of different products, teams, projects, and changing circumstances over time, but the disclosure is not limited thereto, but the disclosure is not limited thereto.

Thus, the relative estimation and sizing recommendation module disclosed herein bridges the gap between the intuitive, rapid estimation enabled by T-shirt sizing approach and the concrete, data-driven planning needed for effective project management—by providing this “translation” between abstract sizes and concrete story points, thereby enabling: more accurate resource planning and allocation; improving cross-team and cross-project comparisons; better alignment between estimation and actual effort; enhancing ability to track and improve estimation accuracy over time, etc., but the disclosure is not limited thereto.

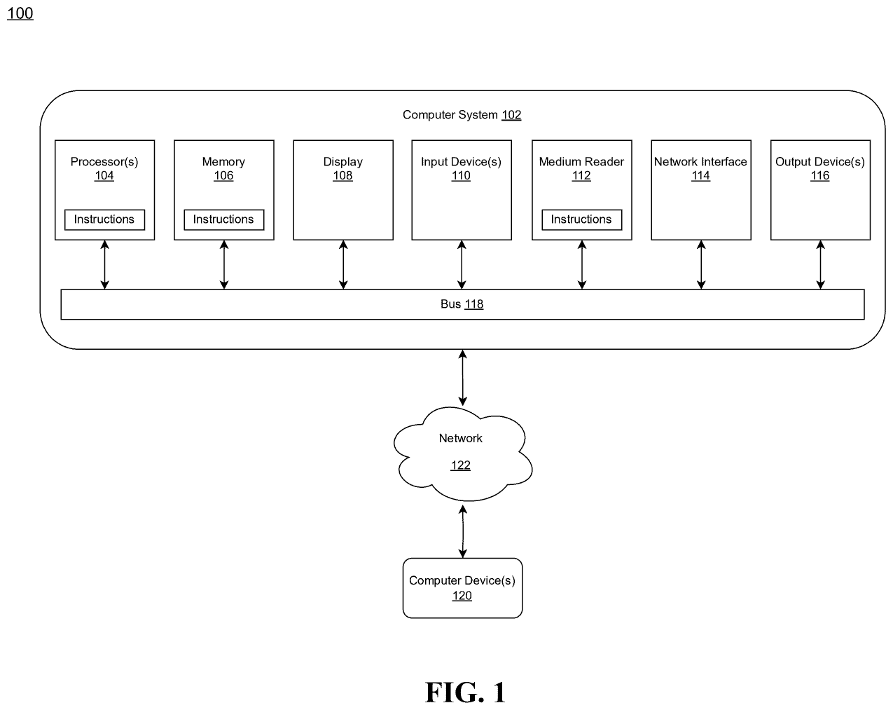

FIG. 1 is an exemplary system 100 for use in implementing a platform, language, database, and cloud agnostic relative estimation and sizing recommendation module configured to automatically and dynamically analyze, group, and categorize story point data in an agile project management tool in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the relative estimation and sizing recommendation module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the relative estimation and sizing recommendation module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionalities as described herein, and a processor described herein may be used to support a virtual processing environment.

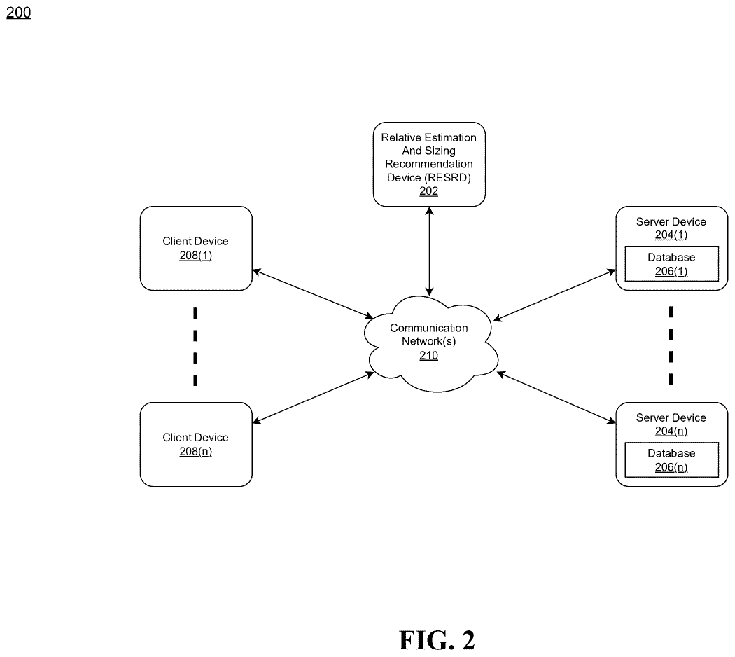

Referring to FIG. 2, a schematic of an exemplary network environment 200 for implementing a language, platform, database, and cloud agnostic relative estimation and sizing recommendation device (RESRD) of the instant disclosure is illustrated.

In some embodiments, the above-described problems associated with conventional tools may be overcome by implementing an RESRD 202 as illustrated in FIG. 2 that may be configured for implementing a platform, language, database, and cloud agnostic relative estimation and sizing recommendation module configured to automatically analyze, group, and categorize story point data for dynamically mapping features data corresponding to products and teams to story points in agile project management systems and processes, thereby substantially improving processing speed of overall system in connection with the project management systems and processes and protecting the overall system from potential data breach, but the disclosure is not limited thereto.

The RESRD 202 may have one or more computer system 102s, as described with respect to FIG. 1, which in aggregate provide the necessary functions.

The RESRD 202 may store one or more applications that may include executable instructions that, when executed by the RESRD 202, cause the RESRD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RESRD 202 itself, may be located in virtual server(s) running in a cloud-based computing environment rather than being tied to one or more specific physical network computing devices. Also, the application(s) may be running in one or more virtual machines (VMs) executing on the RESRD 202. Additionally, in one or more embodiments of this technology, virtual machine(s) running on the RESRD 202 may be managed or supervised by a hypervisor.

In the network environment 200 of FIG. 2, the RESRD 202 may be coupled to a plurality of server devices 204(1)-204(n) that hosts a plurality of databases 206(1)-206(n), and also to a plurality of client devices 208(1)-208(n) via communication network(s) 210. A communication interface of the RESRD 202, such as the network interface 114 of the computer system 102 of FIG. 1, operatively couples and communicates between the RESRD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RESRD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The RESRD 202 may be a standalone device or integrated with one or more other devices or apparatuses, such as one or more of the server devices 204(1)-204(n). In some embodiments, the RESRD 202 may be hosted by one of the server devices 204(1)-204(n), and other arrangements may also be possible. Moreover, one or more of the devices of the RESRD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the RESRD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the RESRD 202 that may efficiently provide a platform for implementing a platform, language, database, and cloud agnostic relative estimation and sizing recommendation module configured to automatically analyze, group, and categorize story point data for dynamically mapping features data corresponding to products and teams to story points in agile project management systems and processes, thereby substantially improving processing speed of overall system in connection with the project management systems and processes and protecting the overall system from potential data breach, but the disclosure is not limited thereto.

The client devices 208(1)-208(n) may run interface applications, such as standard web browsers or standalone client applications, which may provide an interface to communicate with the RESRD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the RESRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the RESRD 202, the server devices 204(1)-204(n), or the client devices 208(1)-208(n), in some embodiments, may be configured to operate as virtual instances on the same physical machine. In some embodiments, one or more of the RESRD 202, the server devices 204(1)-204(n), or the client devices 208(1)-208(n) may operate on the same physical device rather than as separate devices communicating through communication network(s) 210. Additionally, there may be more or fewer RESRDs 202, server devices 204(1)-204(n), or client devices 208(1)-208(n) than illustrated in FIG. 2. In some embodiments, the RESRD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

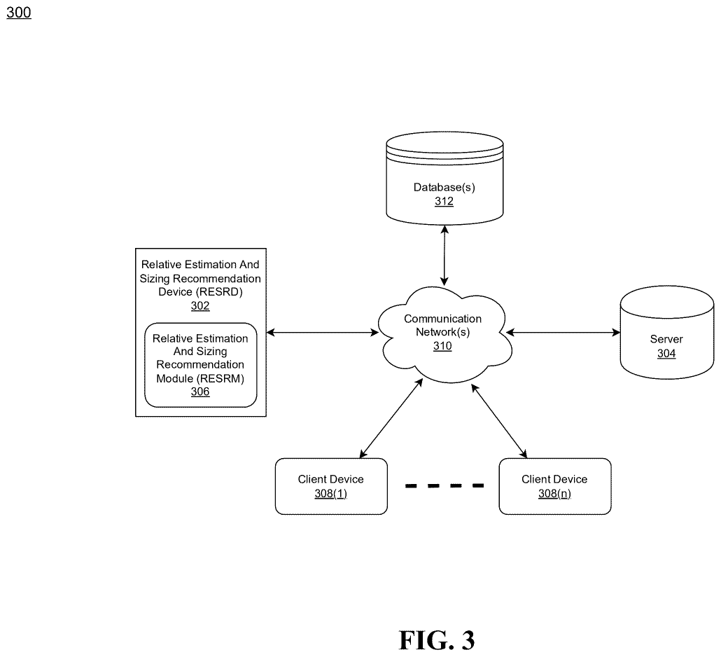

FIG. 3 illustrates a system diagram for implementing a platform, language, and cloud agnostic RESRD having a platform, language, database, and cloud agnostic relative estimation and sizing recommendation module (RESRM) in accordance with an embodiment.

As illustrated in FIG. 3, the system 300 may include an RESRD 302 within which an RESRM 306 may be embedded, a server 304, a database(s) 312, a plurality of client devices 308(1) . . . 308(n), and a communication network 310.

In some embodiments, the RESRD 302 including the RESRM 306 may be connected to the server 304, and the database(s) 312 via the communication network 310. The RESRD 302 may also be connected to the plurality of client devices 308(1) . . . 308(n) via the communication network 310, but the disclosure is not limited thereto.

According to exemplary embodiment, the RESRD 302 is described and shown in FIG. 3 as including the RESRM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the RESRM 306 may be configured to receive real-time feed of data from the plurality of client devices 308(1) . . . 308(n) and secondary sources via the communication network 310.

As may be described below, the RESRM 306 may be configured to: train a machine learning model with historical story point data corresponding to a project to be developed via the project management tool; implement a clustering algorithm, by utilizing the machine learning model, that automatically generates T-shirt size categories based on the historical story point data; dynamically generate first mappings data that corresponds to relationships between the T-shirt size and the historical story point data at various levels recognizing that different contexts require different scales of measurement to complete the project; implement a learning algorithm onto the project management tool, by utilizing the machine learning model, for the machine learning model to continuously learn and adjust mappings based on new project data thereby improving performance of the project management tool, providing team-specific and project-specific recommendations data that evolve over time; display the recommendations data onto a graphical user interface that provides a platform for decision making and planning in completing the project; and receive user input, via the graphical user interface, to complete the project, but the disclosure is not limited thereto.

The plurality of client devices 308(1) . . . 308(n) are illustrated as being in communication with the RESRD 302. In this regard, the plurality of client devices 308(1) 308 (n) may be “clients” (e.g., customers) of the RESRD 302 and are described herein as such. Nevertheless, it is to be known and understood that the plurality of client devices 308(1) . . . 308(n) need not necessarily be “clients” of the RESRD 302, or any entity described in association therewith herein. Any additional or alternative relationship may exist between either or both of the plurality of client devices 308(1) . . . 308(n) and the RESRD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the RESRD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The RESRD 302 may be the same or similar to the RESRD 202 as described with respect to FIG. 2, including any features or combination of features described with respect thereto.

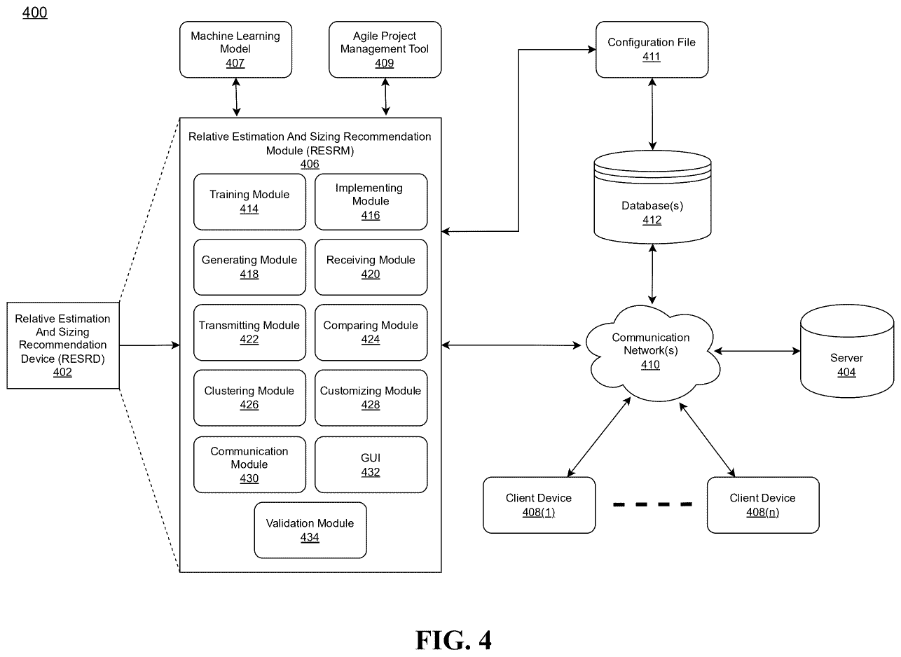

FIG. 4 illustrates a system diagram for implementing a platform, language, database, and cloud agnostic RESRM of FIG. 3 in accordance with an exemplary embodiment.

In some embodiments, the system 400 may include a platform, language, database, and cloud agnostic RESRD 402 within which a platform, language, database, and cloud agnostic RESRM 406 may be embedded, a server 404, a machine learning model 407, an agile project management tool 409, database(s) 412, and a communication network 410. In some embodiments, server 404 may comprise a plurality of servers located centrally or located in different locations, but the disclosure is not limited thereto.

In some embodiments, the RESRD 402 including the RESRM 406 may be connected to the server 404, the machine learning 407, the project management tool 409, and the database(s) 412 via the communication network 410. The RESRD 402 may also be connected to the plurality of client devices 408(1)-408(n) via the communication network 410, but the disclosure is not limited thereto. The RESRM 406, the server 404, the plurality of client devices 408(1)-408(n), the database(s) 412, the communication network 410 as illustrated in FIG. 4 may be the same or similar to the RESRM 306, the server 304, the plurality of client devices 308(1)-308(n), the database(s) 312, the communication network 310, respectively, as illustrated in FIG. 3.

In some embodiments, as illustrated in FIG. 4, the RESRM 406 may include a training module 414, an implementing module 416, a generating module 418, a receiving module 420, a transmitting module 422, a comparing module 424, a clustering module 426, a customizing module 428, a communication module 430, a Graphical User Interface (GUI) 432, and a validation module 434. In some embodiments, interactions and data exchange among these modules included in the RESRM 406 provide the advantageous effects of the disclosed invention. Functionalities of each module of FIG. 4 may be described in detail below with reference to FIGS. 4-7.

In some embodiments, each of the training module 414, implementing module 416, generating module 418, receiving module 420, transmitting module 422, comparing module 424, clustering module 426, customizing module 428, the communication module 430, and the validation module 434 of the RESRM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the training module 414, implementing module 416, generating module 418, receiving module 420, transmitting module 422, comparing module 424, clustering module 426, customizing module 428, and the communication module 430, and the validation module 434 of the RESRM 406 of FIG. 4 may be implemented by microprocessors or similar, and may be programmed using software (e.g., microcode) to perform various functions discussed herein and may optionally be driven by firmware and/or software.

Alternatively, in some embodiments, each of the training module 414, implementing module 416, generating module 418, receiving module 420, transmitting module 422, comparing module 424, clustering module 426, customizing module 428, and the communication module 430, and the validation module 434 of the RESRM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the RESRM 406 of FIG. 4 may also be implemented by cloud-based deployment. In some embodiments, a single API call may invoke each of the training module 414, implementing module 416, generating module 418, receiving module 420, transmitting module 422, comparing module 424, clustering module 426, customizing module 428, and the communication module 430, and the validation module 434 of the RESRM 406 of FIG. 4 (in complete or in part) either sequentially or parallelly based on flow design, but the disclosure is not limited thereto.

In some embodiments, each of the training module 414, implementing module 416, generating module 418, receiving module 420, transmitting module 422, comparing module 424, clustering module 426, customizing module 428, and the communication module 430, and the validation module 434 of the RESRM 406 of FIG. 4 may be called via corresponding API, but the disclosure is not limited thereto. For example, in some embodiments, the training module 414 may be called via a first API, the implementing module 416 may be called via a second API, the generating module 418 may be called via a third API, the receiving module 420 may be called via a fourth API, the transmitting module 422 may be called via a fifth API, the comparing module 424 may be called via a sixth API, the clustering module 426 may be called via a seventh API, the customizing module 428 may be called via an eight API, the communication module 430 may be called via a ninth API, the validation module 434 may be called via a tenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the RESRM 406 may be executed via the communication module 430, and the communication network 410, which may comprise plural networks as described above. In some embodiments, in an exemplary embodiment, the various components of the RESRM 406 may communicate with the server 404, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

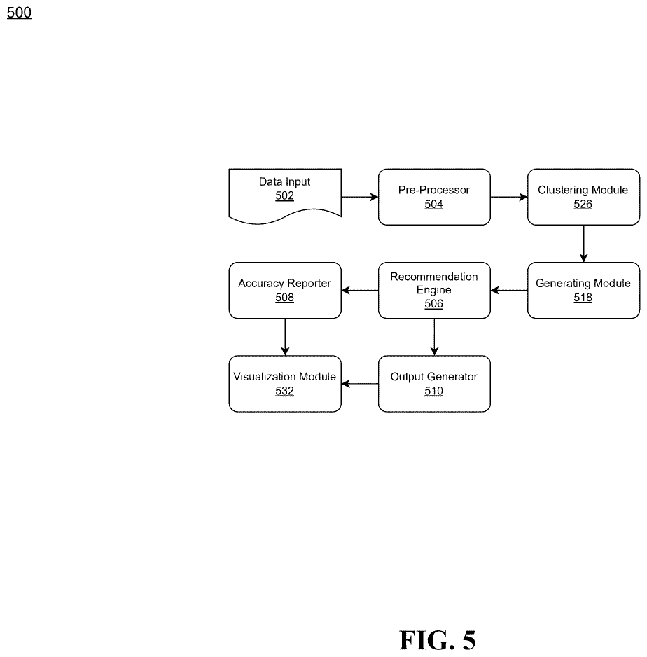

FIG. 5 illustrates an architecture diagram 500 implemented by the platform, language, database, and cloud agnostic RESRM 406 of FIG. 4 for automatically and dynamically analyzing, grouping, and categorizing story point data in an agile project management tool 409 in accordance with an embodiment. As illustrated in FIG. 5, data input 502 may be received by the pre-processor 504 by calling the receiving module 420 via the fourth API (see FIG. 4). Output data of the pre-processor 504 may be input to the clustering module 526 which may apply a clustering algorithm to output data. The output data from the clustering module 526 may be input to the generating module 518. Output data from the generating module 518 may be input to the recommendation engine 506. Output data from the recommendation engine 506 may be input to both the output generator 510 and the accuracy reporter 408. Output data from the accuracy reporter 508 may be input to the visualization module 532. Output data from the output generator 510 may also be input to the visualization module 532. The GUI 432 as illustrated in FIG. 4 may include the accuracy reporter 508, visualization module 532, and the output generator 510.

For example, by implementing the architecture diagram 500 of FIG. 5 by the RESRM 406 of FIG. 4, the RESRM 406 may be configured to automatically calibrate T-shirt size mentioned earlier using machine learning techniques, specifically K-means clustering discussed above, and automatically generate T-shirt size categories based on historical story point data. This removes the subjectivity often associated with defining size boundaries.

The recommendation engine 506 may be configured to generate multi-level recommendations. For example, the RESRM 406 may provide T-Shirt size to Story Point mappings at various levels-Initiative, Epic, Project, and Team-recognizing that different contexts may require different scales of measurement.

By continuously incorporating new project data, the RESRM 406 may evolve its mappings over time, adapting to changing team velocities or project complexities. Moreover, the visualization module 532 may be configured to provide visual aids to help teams understand and interpret the mappings, making the abstract concepts more tangible.

In addition, the RESRM 406 is configured to handle real-world data inconsistencies, such as missing theme categorizations or forecasts, ensuring its applicability across various project management structures.

These processes mentioned above as implemented by RESRM 406 may provide agile teams with an intuitive estimation tool while maintaining the precision needed for detailed capacity planning and velocity calculations. The RESRM 406, by implementing the recommendation engine 506, may output tailored recommendations for products, teams, and projects, accompanied by visualizations and accuracy reports, to improve estimation accuracy and decision-making in agile environments. Specifically, the machine learning model 407, as implemented, trained, and retrained by the RESRM 406, may be configured to continuously learn and adapt its recommendations as new project data is incorporated, ensuring ongoing relevance and accuracy in diverse and evolving agile contexts.

Moreover, by implementing the processes mentioned above by the RESRM 406, the RESRM 406 may be configured to transform the abstract “T-shirt store” of agile estimation into a precisely calibrated system, where teams may confidently “try on” estimates and know exactly how they translate to real-world effort. This represents a significant advancement in agile project management, combining the best of intuitive, rapid estimation techniques with data-driven accuracy and adaptability.

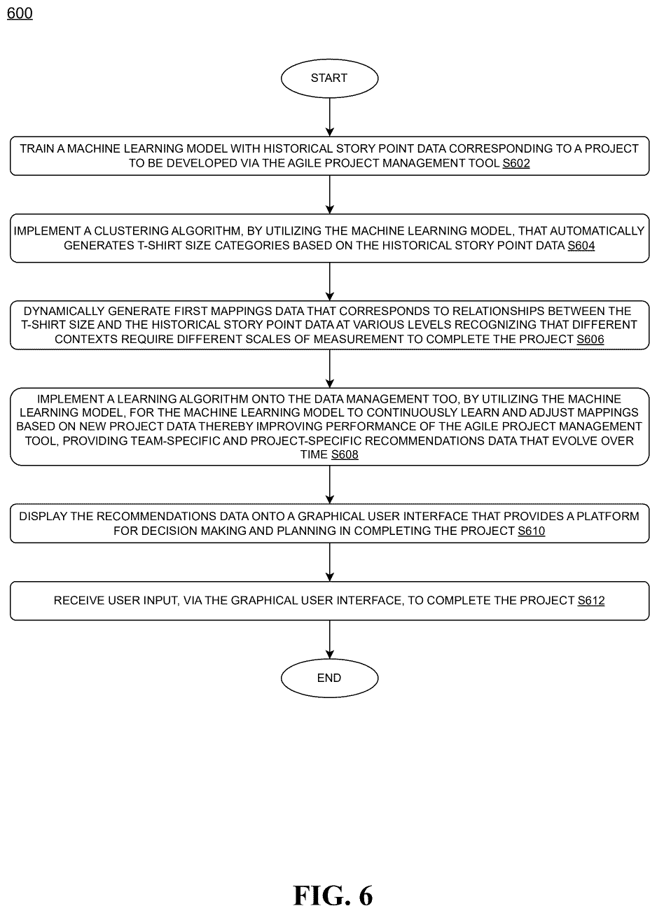

FIG. 6 illustrates a flow chart of a process 600 implemented by the platform, language, database, and cloud agnostic RESRM 406 of FIG. 4 for automatically and dynamically analyzing, grouping, and categorizing story point data in an agile project management tool in accordance with an embodiment. It may be appreciated that the illustrated process 600 and associated steps may be performed in a different order, with illustrated steps omitted, with additional steps added, or with a combination of reordered, combined, omitted, or additional steps.

For example, referring back to FIGS. 4-6, in some embodiments, at step S602, the process 600 may include training, by calling the training module 414 (see FIG. 4) via the first API, training the machine learning model 407 with historical story point data corresponding to a project to be developed via the project management tool 409. In some embodiments, both the T-shirt size and the story point as disclosed herein may correspond to a forecasting technique in estimating effort required for various tasks corresponding to the project, but the disclosure is not limited thereto.

As mentioned earlier, existing solutions typically employ static, subjective (i.e., manual) mappings between T-shirt sizes and story points, leading to inconsistencies and inaccuracies. These predefined mappings do not account for the unique characteristics and historical performance of individual products, teams or projects, resulting in a one-size-fits-all approach that may not suit all scenarios, thereby substantially reducing performance of the project management tool, reducing processing speed of the project management tool in delivering a project, failing to adapt to changing team dynamics, and subjecting the project management tool to various malicious data breach, etc., due to the manual nature of data mapping

The RESRM 406 disclosed herein may be configured to implement artificial intelligence and machine learning algorithms to automatically analyze, group, and categorize story point data for dynamically mapping features data corresponding to products and teams to story points in agile project management systems and processes, thereby substantially improving processing speed of overall system in connection with the project management systems and processes and protecting the overall system from potential data breach, but the disclosure is not limited thereto.

For example, the recommendation engine 506 as illustrated in FIG. 5, as implemented by the RESRM 406, by leveraging machine learning-particularly, K-means clustering, may be configured to analyze historical data to generate adaptive, data-driven mappings between intuitive T-shirt sizes and precise story points, thereby automatically adapting to changing team dynamics or project complexities, effectively handling complex patterns and outliers accounting for the nuances of different products, teams, projects, and changing circumstances over time, but the disclosure is not limited thereto.

The RESRM 406 first initializes itself with a configuration dictionary (e.g., JSON). This configuration may include the number of T-shirt sizes, size labels, and logging preferences. This flexibility ensures that the RESRM 406 may be seamlessly integrated into various agile environments, including the agile management tool 409, supporting different estimation methodologies and organizational practices.

The receiving module 420 may be called via the fourth API by the RESRM 406 for data loading and reading the (.CSV, live data connection) file containing historical project data (may be plugged into any agile project management data pipeline, e.g. Jira, Trello etc.). The RESRM 406 then may check for required columns: epicName/Key: Name/Unique identifier of the epic; actualSP: Actual story points assigned to completed work; parentInitiative: The parent initiative of the epic; team: The team responsible for the work; projectKey: Unique identifier for the project; leadTime: Time taken to complete the task, time-to-market, in days; theme (optional): Thematic categorization of the work, parent to Initiatives; forecast (optional): Previously estimated story points, etc., but the disclosure is not limited thereto. The RESRM 406 may execute rigorous data validation, by calling the validation module 434 via the tenth API, to ensure completeness and correctness of the input data checking for missing values, data type mismatches, and other potential errors. “Epic” as disclosed herein may refer to “features” corresponding to the project.

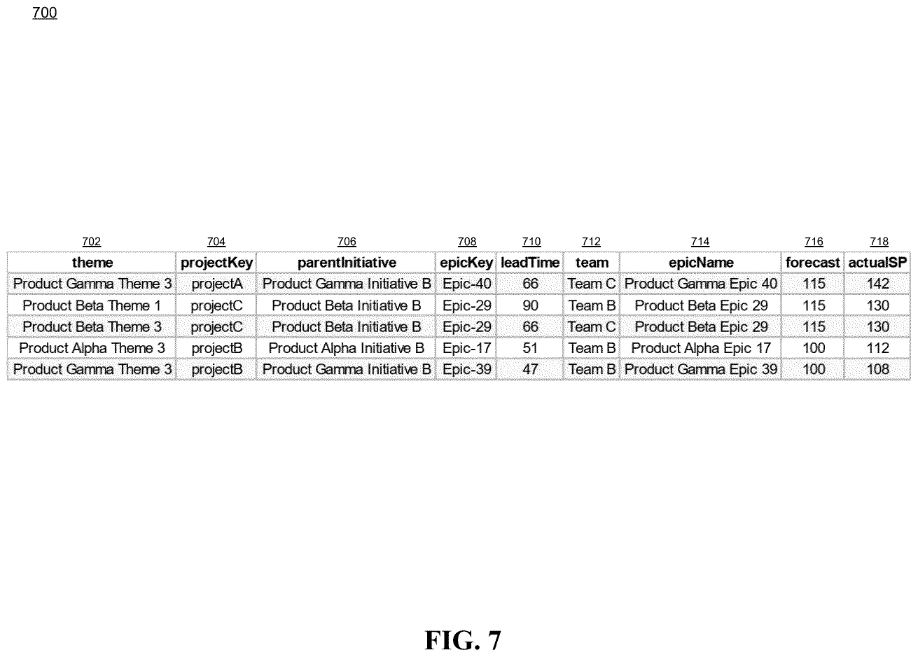

FIG. 7 illustrates a table 700 of input data utilized by the RESRM 406 of FIG. 4 in accordance with an embodiment. As illustrated in the table 700, the input data may include theme 702, projectKey 704, parentInitiative 706, epicKey 708, leadTime 710, team 712, epicname 714, forecast 716, and actualSP 718.

Referring back to FIGS. 4-6, at step S604, the process 600 implemented by the RESRM 406 may include, implementing, by calling the implementing module 416 via the second API, a clustering algorithm, by utilizing the machine learning model 407, that automatically generates T-shirt size categories based on the historical story point data. In some embodiments, in implementing the clustering algorithm, the process 600 at step S604 may further include: implementing, by calling the implementing module 416 via the second API, a K-means clustering algorithm; and grouping, by calling the clustering module 426 via the seventh API, similar story point values into a number of clusters, each corresponding to a specific T-shirt size. Moreover, the process 600 at step S604 may further include customizing, by calling the customizing module 428 via the eight API, the number of clusters as defined during initialization and configuration as discussed above in connection with developing the project.

In some embodiments, the various levels may include initiative level, feature level, project level, and team level corresponding to the project to be developed via the project management tool 409, but the disclosure is not limited thereto. For example, the clustering module 426 may aggregate the story points at multiple levels: Theme level: Aggregation of story points for a Portfolio of Products; Project level: Aggregation by project, offering a holistic view of estimation data, assuming each project is dedicated to a product, includes Initiatives and Epics; Team level: Aggregation by team, reflecting collective performance-includes Epics.

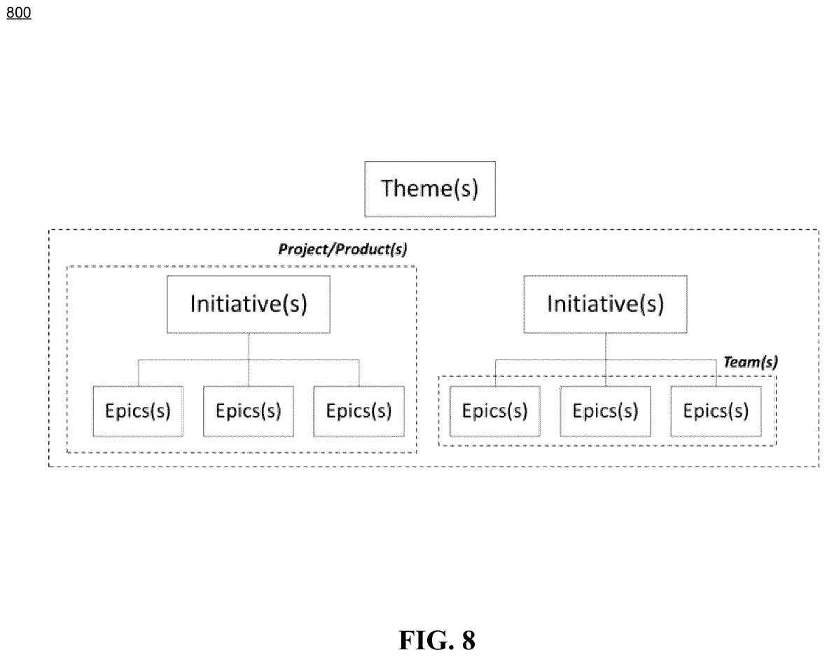

This clustering algorithm standardizes the data, preparing it for accurate clustering and analysis, ensuring meaningful and actionable insights. For example, FIG. 8 illustrates an architecture 800 implemented by the RESRM 406 of FIG. 4 that illustrates top-down relationship between story point data mentioned earlier in accordance with an embodiment.

For example, a K-means clustering model is trained by the training module 414 on the pre-processed data thereby grouping, by calling the clustering module 426 via the seventh API, similar story point values into clusters, each corresponding to a specific T-shirt size. The RESRM 406 may be configured to allow for customization, by calling the customizing module 428 via the eighth API, of the number of clusters (e.g., 5 clusters for XS, S, M, L, XL) as defined during initialization and configuration.

Clustering parameters may be configurable to suit the specific needs of the product, project, team or organization. The clustering process as implemented by the RESRM 406 may ensure that the resulting T-shirt size to story point mappings are both accurate and reflective of the team's historical performance. For example, the clustering algorithm executed by the clustering module 426 utilizes the k-means++ algorithm (a data mining technique that improves upon the standard K-means algorithm for clustering data points) for initial centroid selection; chooses initial centroids that are far apart to improve clustering quality; runs multiple iterations with different initial centroids; and selects the best result based on the lowest within-cluster sum of squares.

Referring back to FIGS. 4-6 again, at step S606, the process 600 implemented by the RESRM 406 of FIG. 4 may include dynamically generating, by calling the generating module 418 via the third API, first mappings data that corresponds to relationships between the T-shirt size and the historical story point data at various levels recognizing that different contexts require different scales of measurement to complete the project.

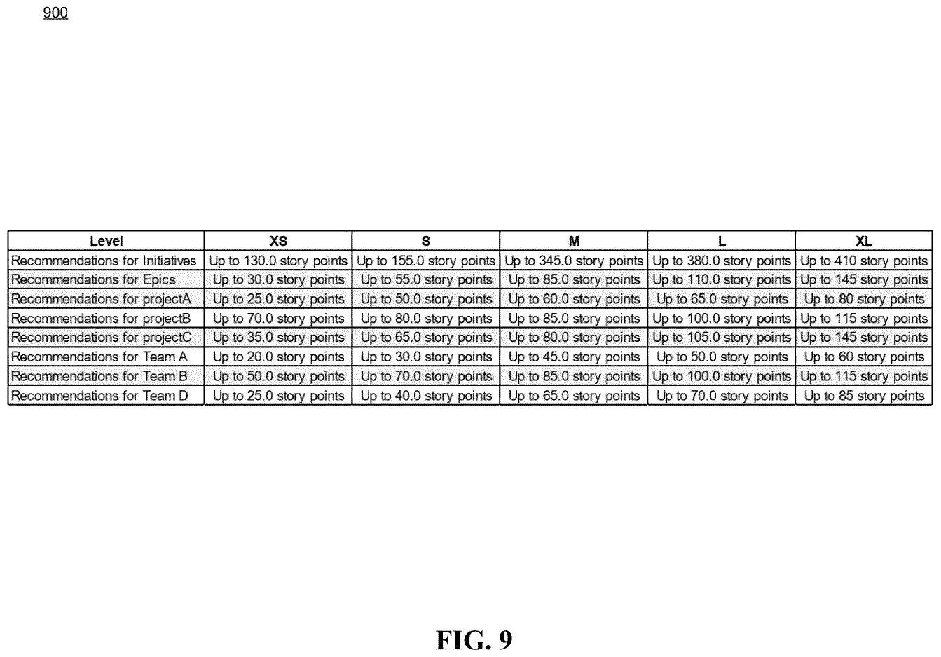

At step S608, the process 600 implemented by the RESRM 406 of FIG. 4 may include implementing, by calling the implementing module 416 via the second API, a learning algorithm onto the agile project management tool 409, by utilizing the machine learning model 407, for the machine learning model 407 to continuously learn and adjust mappings based on new project data thereby improving performance of the agile project management tool 409, providing team-specific and project-specific recommendations data that evolve over time. FIG. 9 illustrates a table 900 of recommendations output by the RESRM 406 of FIG. 4 in accordance with an embodiment.

In some embodiments, in implementing the learning algorithm, at step S608, the process 600 implemented by the RESRM 406 of FIG. 4 may further include periodically transmitting, by calling the transmitting module 422 via the fifth API, new updated dataset corresponding to the project into the agile project management tool 409; re-running, by utilizing the machine learning model 407, the clustering algorithm of step 604 on the new updated dataset; and generating by calling the generating module 418 via the third API, in response to re-running, new mappings data that maps new T-shirt size to the historical story point data based on results data output by re-running the clustering algorithm.

Additionally, in some embodiments, in implementing the learning algorithm, at step S608, the process 600 implemented by the RESRM 406 of FIG. 4 may further include comparing by calling the comparing module 424 via the sixth API, by utilizing the visualization module 532 and the accuracy reporter (see FIG. 5) the new mappings data with the first mappings data to identify trends or significant shifts; generating, by calling the generating module 418 via the third API, difference data in response to comparing the new mappings data with the first mappings data; and re-training, by calling the training module 414 via the first API, the machine learning model 407 with the difference data thereby improving performance of the machine learning model 407.

At step S610, the process 600 implemented by the RESRM 406 of FIG. 4 may include displaying the recommendations data onto GUI 432 that provides a platform for decision making and planning in completing the project by utilizing the accuracy reporter 508, the output generator 510, and the visualization module 532.

Referring back to FIG. 5, for example, the output generator 510 may create dynamic mappings between T-shirt sizes and story point ranges, adapting these mappings based on clustering results and underlying data patterns. It uses the cluster centroids to define boundaries between sizes as mentioned earlier.

These mappings may be recalibrated as new data is fed into the system 400 or the RESRM 406 (see FIG. 4), ensuring that recommendations remain relevant and precise over time. The recommendation engine 506 may provide tailored estimations at multiple levels, a custom rounding functionality (nearest 5 or 10, closest upper bound) ensures user-friendly story point values.

For example, aggregate level (Theme, Initiative, and Epics) recommendations may include broad-level recommendations for large bodies of work—these would typically encompass a Portfolio of Products; Project level recommendations may include specific recommendations for individual projects, accounting for unique project characteristics—these would typically include data for dedicated projects aligned to a Product or Area-Product, encompassing multiple Teams; Team level recommendations may include customized recommendations for teams, factoring in their velocity, historical performance, and domain expertise-highly customized and adapted to a team's granular characteristics, but the disclosure is not limited thereto. These recommendations may enhance estimation accuracy and consistency across different levels of work breakdown, reducing variability and uncertainty. For example, FIG. 9 illustrates a table 900 of recommendations output by the RESRM 406 of FIG. 4 by utilizing the recommendation engine 506 and the output generator 510 in accordance with an embodiment.

In some embodiments, the visualization module 532 may generate a suite of charts to aid in decision-making, allowing users to explore data in detail and make informed decisions based on the insights provided, these may include, but not limited thereto: i) story points vs. lead time scatter plots—visualizing the relationship between story points and lead time, aiding in capacity planning, particularly the relationship between story points and time; ii) stacked bar charts—displaying the percentage of story points per theme or initiative, broken down by team—showcases distribution of allocated capacity (actual story points delivered) for an organization/team (if the ‘theme’ column 702 as illustrated in FIG. 7 is missing, it falls back to using ‘parentInitiative’ 706 for grouping); iii) forecast vs. actual story points bar charts-comparing forecasted and actual story points, offering insight into estimation accuracy.

The RESRM 406 may also be configured to handle outliers and anomalous data: i) Outliers are visualized for review but not automatically removed, as they may represent valuable edge cases in valid cases, they represent the upper limit for a T-shirt size recommendation; ii) Users have the option to review and manually exclude identified outliers if deemed necessary; iii) the RESRM 406 may maintain a log of all data points identified as potential outliers for transparency and future analysis.

For example, the accuracy reporter 508 may generate a detailed accuracy report (if a forecast column 716 is available (see FIG. 7)) that compares forecasted story points to actual story points for completed work.

For example, key metrics include: Forecasted story points as a percentage of Actual story points (forecast_vs_actual_pct); and Variance between Forecast and Actual story points (variance_pct). This report helps teams identify patterns in their estimation accuracy, enabling continuous improvement and refinement of estimation techniques. An example of sample accuracy report output by the accuracy reporter 508 is represented below in TABLE 1.

TABLE 1

| | | | differ- | forecast_vs_{—} | variance_{—} |
|---|---|---|---|---|---|
| epicName | actualSP | forecast | ence | actual_pct | pct |
| Tech Epic 1 | 15 | 20 | −5 | 133.33 | −25 |
| Tech Epic 2 | 40 | 50 | −10 | 125.00 | −20 |
| Tech Epic 3 | 75 | 50 | 25 | 66.67 | 50 |

At step S612, the process 600 implemented by the RESRM 406 of FIG. 4 may include receiving user input based on analyzing the accuracy report, via the GUI 432, to complete the project.

In some embodiments, the RESRD 402 may include a memory (e.g., a memory 106 as illustrated in FIG. 1) which may be a non-transitory computer readable medium that may be configured to store instructions for implementing a platform, language, database, and cloud agnostic RESRM 406 for automatically analyzing, grouping, and categorizing story point data for dynamically mapping features data corresponding to products and teams to story points in agile project management systems and processes as disclosed herein. The RESRD 402 may also include a medium reader (e.g., a medium reader 112 as illustrated in FIG. 1) which may be configured to read any one or more sets of instructions, e.g., software, from any of the memories described herein. The instructions, when executed by a processor embedded within the RESRM 406 or within the RESRD 402, may be used to perform one or more of the processes as described herein. In a particular embodiment, the instructions may reside completely, or at least partially, within the memory 106, the medium reader 112, and/or the processor 104 (see FIG. 1) during execution by the RESRD 402.

In some embodiments, the instructions, when executed, may cause a processor embedded within the RESRM 406 or the RESRD 402 to perform the following: training a machine learning model with historical story point data corresponding to a project to be developed via the project management tool; implementing a clustering algorithm, by utilizing the machine learning model, that automatically generates T-shirt size categories based on the historical story point data; dynamically generating first mappings data that corresponds to relationships between the T-shirt size and the historical story point data at various levels recognizing that different contexts require different scales of measurement to complete the project; implementing a learning algorithm onto the project management tool, by utilizing the machine learning model, for the machine learning model to continuously learn and adjust mappings based on new project data thereby improving performance of the project management tool, providing team-specific and project-specific recommendations data that evolve over time; displaying the recommendations data onto a graphical user interface that provides a platform for decision making and planning in completing the project; and receiving user input, via the graphical user interface, to complete the project. In some embodiments, the processor may be the same or similar to the processor 104 as illustrated in FIG. 1 or the processor embedded within the RESRD 202, RESRD 302, RESRD 402, and RESRM 406 which may be the same or similar to the processor 104.

In some embodiments, in implementing the learning algorithm, the instructions, when executed, may cause the processor 104 to further perform the following: periodically transmitting new updated dataset corresponding to the project into the project management tool; re-running, by utilizing the machine learning model, the clustering algorithm on the new updated dataset; and generating, in response to re-running, new mappings data that maps new T-shirt size to the historical story point data based on results data output by re-running the clustering algorithm.

In some embodiments, the instructions, when executed, may cause the processor 104 to further perform the following: comparing, by utilizing the graphical user interface, the new mappings data with the first mappings data to identify trends or significant shifts; generating difference data in response to comparing the new mappings data with the first mappings data; and re-training the machine learning model with the difference data thereby improving performance of the machine learning model.

In some embodiments, in implementing the clustering algorithm, the instructions, when executed, may cause the processor 104 to further perform the following: implementing a K-means clustering algorithm; and grouping similar story point values into a number of clusters, each corresponding to a specific T-shirt size.

In some embodiments, the instructions, when executed, may cause the processor 104 to further perform the following: customizing the number of clusters as defined during initialization and configuration in connection with developing the project.

In some embodiments according to the non-transitory computer readable medium, both the T-shirt size and the story point may correspond to a forecasting technique in estimating effort required for various tasks corresponding to the project, but the disclosure is not limited thereto.

In some embodiments according to the non-transitory computer readable medium, the various levels may include initiative level, feature level, project level, and team level corresponding to the project to be developed via the project management tool, but the disclosure is not limited thereto.

In some embodiments as disclosed above in FIGS. 1-6, technical improvements effected by the instant disclosure may include a platform for implementing a platform, language, database, and cloud agnostic relative estimation and sizing recommendation module configured to automatically analyze, group, and categorize story point data for dynamically mapping features data corresponding to products and teams to story points in agile project management systems and processes, thereby substantially improving processing speed of overall system in connection with the project management systems and processes and protecting the overall system from potential data breach, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for improving performance of a project management tool by utilizing one or more processors along with allocated memory, the method comprising:
training a machine learning model with historical story point data corresponding to a project to be developed via the project management tool;
implementing a clustering algorithm, by utilizing the machine learning model, that automatically generates T-shirt size categories based on the historical story point data;
dynamically generating first mappings data that corresponds to relationships between the T-shirt size and the historical story point data at various levels recognizing that different contexts require different scales of measurement to complete the project;
implementing a learning algorithm onto the project management tool, by utilizing the machine learning model, for the machine learning model to continuously learn and adjust mappings based on new project data thereby improving performance of the project management tool, providing team-specific and project-specific recommendations data that evolve over time;
displaying the recommendations data onto a graphical user interface that provides a platform for decision making and planning in completing the project; and
receiving user input, via the graphical user interface, to complete the project.

2. The method of claim 1, wherein in implementing the learning algorithm, the method further comprising:
periodically transmitting new updated dataset corresponding to the project into the project management tool;
re-running, by utilizing the machine learning model, the clustering algorithm on the new updated dataset; and
generating, in response to re-running, new mappings data that maps new T-shirt size to the historical story point data based on results data output by re-running the clustering algorithm.

3. The method of claim 2, further comprising:
comparing, by utilizing the graphical user interface, the new mappings data with the first mappings data to identify trends or significant shifts;
generating difference data in response to comparing the new mappings data with the first mappings data; and
re-training the machine learning model with the difference data thereby improving performance of the machine learning model.

4. The method of claim 1 wherein in implementing the clustering algorithm, the method further comprising:
implementing a K-means clustering algorithm; and
grouping similar story point values into a number of clusters, each corresponding to a specific T-shirt size.

5. The method of claim 4, further comprising:
customizing the number of clusters as defined during initialization and configuration in connection with developing the project.

6. The method of claim 1, wherein both the T-shirt size and the story point correspond to a forecasting technique in estimating effort required for various tasks corresponding to the project.

7. The method of claim 1, wherein the various levels include initiative level, feature level, project level, and team level corresponding to the project to be developed via the project management tool.

8. A system for improving performance of a project management tool, the system comprising:
a processor; and
a memory operatively connected to the processor via a communication interface, the memory storing computer readable instructions, when executed, causes the processor to:
train a machine learning model with historical story point data corresponding to a project to be developed via the project management tool;
implement a clustering algorithm, by utilizing the machine learning model, that automatically generates T-shirt size categories based on the historical story point data;
dynamically generate first mappings data that corresponds to relationships between the T-shirt size and the historical story point data at various levels recognizing that different contexts require different scales of measurement to complete the project;
implement a learning algorithm onto the project management tool, by utilizing the machine learning model, for the machine learning model to continuously learn and adjust mappings based on new project data thereby improving performance of the project management tool, providing team-specific and project-specific recommendations data that evolve over time;
display the recommendations data onto a graphical user interface that provides a platform for decision making and planning in completing the project; and
receive user input, via the graphical user interface, to complete the project.

9. The system of claim 8, wherein in implementing the learning algorithm, the processor is further configured to:
periodically transmit new updated dataset corresponding to the project into the project management tool;
re-run, by utilizing the machine learning model, the clustering algorithm on the new updated dataset; and
generate, in response to re-running, new mappings data that maps new T-shirt size to the historical story point data based on results data output by re-running the clustering algorithm.

10. The system of claim 9, wherein the processor is further configured to:
compare, by utilizing the graphical user interface, the new mappings data with the first mappings data to identify trends or significant shifts;
generate difference data in response to comparing the new mappings data with the first mappings data; and
re-train the machine learning model with the difference data thereby improving performance of the machine learning model.

11. The system of claim 8 wherein in implementing the clustering algorithm, the processor is further configured to:
implement a K-means clustering algorithm; and
group similar story point values into a number of clusters, each corresponding to a specific T-shirt size.

12. The system according to claim 11, wherein the processor is further configured to:
customize the number of clusters as defined during initialization and configuration in connection with developing the project.

13. The system of claim 8, wherein both the T-shirt size and the story point correspond to a forecasting technique in estimating effort required for various tasks corresponding to the project.

14. The system of claim 8, wherein the various levels include initiative level, feature level, project level, and team level corresponding to the project to be developed via the project management tool.

15. A non-transitory computer readable medium configured to store instructions for improving performance of a project management tool, the instructions, when executed, cause a processor to perform the following:
training a machine learning model with historical story point data corresponding to a project to be developed via the project management tool;
implementing a clustering algorithm, by utilizing the machine learning model, that automatically generates T-shirt size categories based on the historical story point data;
dynamically generating first mappings data that corresponds to relationships between the T-shirt size and the historical story point data at various levels recognizing that different contexts require different scales of measurement to complete the project;
implementing a learning algorithm onto the project management tool, by utilizing the machine learning model, for the machine learning model to continuously learn and adjust mappings based on new project data thereby improving performance of the project management tool, providing team-specific and project-specific recommendations data that evolve over time;
displaying the recommendations data onto a graphical user interface that provides a platform for decision making and planning in completing the project; and
receiving user input, via the graphical user interface, to complete the project.

16. The non-transitory computer readable medium of claim 15, wherein in implementing the learning algorithm, the instructions, when executed, cause the processor to further perform the following:
periodically transmitting new updated dataset corresponding to the project into the project management tool;
re-running, by utilizing the machine learning model, the clustering algorithm on the new updated dataset; and
generating, in response to re-running, new mappings data that maps new T-shirt size to the historical story point data based on results data output by re-running the clustering algorithm.

17. The non-transitory computer readable medium of claim 16, wherein the instructions, when executed, cause the processor to further perform the following:
comparing, by utilizing the graphical user interface, the new mappings data with the first mappings data to identify trends or significant shifts;
generating difference data in response to comparing the new mappings data with the first mappings data; and
re-training the machine learning model with the difference data thereby improving performance of the machine learning model.

18. The non-transitory computer readable medium of claim 15 wherein in implementing the clustering algorithm, the instructions, when executed, cause the processor to further perform the following:
implementing a K-means clustering algorithm; and
grouping similar story point values into a number of clusters, each corresponding to a specific T-shirt size.

19. The non-transitory computer readable medium of claim 18, wherein the instructions, when executed, cause the processor to further perform the following:
customizing the number of clusters as defined during initialization and configuration in connection with developing the project.

20. The non-transitory computer readable medium of claim 15, wherein both the T-shirt size and the story point correspond to a forecasting technique in estimating effort required for various tasks corresponding to the project, and wherein the various levels include initiative level, feature level, project level, and team level corresponding to the project to be developed via the project management tool.
